(19) United States
(12) Patent Application Publication
(10) Pub. No.: US 2020/0037642 A1
(43) Pub. Date: Feb. 6, 2020

(54) METHOD FOR MANUFACTURING PEELED NUTS

(71) Applicant: TSUKUBA DIARY PRODUCTS CO., LTD, Ibaraki (JP)

(72) Inventors: HIROSHI EBITSUBO, IBARAKI (JP); SEIJI NEMOTO, IBARAKI (JP)

(21) Appl. No.: 16/523,056

(22) Filed: Jul. 26, 2019

(30) Foreign Application Priority Data
Jul. 31, 2018 (JP) 2018-143462

(51) Int. Cl. A23L 3/375; A23L 25/00; A23L 3/365; A23L 5/20

(52) U.S. Cl. CPC A23L 3/375; A23L 25/00; A23V 2300/20; A23L 5/27; A23V 2002/00; A23L 3/365

(57) ABSTRACT

A method for manufacturing peeled nuts includes: freezing shelled raw material nuts rapidly in a temperature condition of −50° C. or lower; peeling off thin seed coats from the nuts through an agitating or crushing process, in a state in which frozen nuts are frozen as are; and separating and removing the thin seed coats from the nuts in a low-temperature condition in which re-attachment of the thin seed coats to the thin seed coat-peeled nuts does not occur, and obtaining the peeled nuts. In such a configuration, it is possible to efficiently manufacturing high-quality peeled nuts without a damage to an original flavor of the nuts, with little mixing of the seed coats generated through decoating with the decoated nuts, and without the nuts being crushed into too small pieces.

### CROSS-REFERENCE TO RELATED APPLICATIONS

The present application is based on, and claims the benefit of priority from Japanese Patent Application No. 2018-143462, filed on Jul. 31, 2018, the disclosure of which is hereby incorporated by reference herein in its entirety.

### BACKGROUND OF THE INVENTION

### Technical Field

The present invention relates to a method for manufacturing peeled nuts. Specifically, the present invention relates to an efficient method for peeling off thin seed coats from nuts by rapidly freezing the nuts and peeling off and separating thin seed coats in a low-temperature condition in which re-attachment of the thin seed coats does not occur.

### Related Art

In general, a nut is a kernel part of a fruit has a thin seed coat attached to wrap the kernel. Here, examples of nuts include an almond, a Brazil nut, a walnut, a macadamia nut, a pecan nut, a hazelnut, a pistachio, or the like. There is a variety having a thin seed coat that is rich in polyphenols, whereas seed coats have the astringency and the bitterness that practically influence a taste of a product manufactured by using the nuts.

For example, among the nuts, a walnut has a surface that digs into itself in a wavy shaft. Hence, in the related art, a thin seed coat is decoated by hand or a method of using chemicals or the like and melting the thin seed coat is employed. However, it is very difficult to remove the seed coat by hand, and thus it is difficult to increase an amount of production. Hence, removal of the seed coat by hand is unsuitable for satisfying a large demand for nuts. On the other hands, when a decoating method with chemicals is employed, there is a concern that the original taste of nuts will be damaged, and further it is possible to reduce worthiness of the nuts as a health food.

For example, Japanese Patent Application Laid-Open Publication No. 62-239964 A discloses a step of performing a steam or hot water process on an almond kernel and swelling and removing an astringent seed coat early in a manufacturing step of almond powder. However, when this method is employed, it is not possible to ignore an adverse effect of heat on the nuts, and the method is not considered to be suitable for a case where a nut like a walnut has a complex surface shape of a shelled kernel portion.

Japanese Patent Application Laid-Open Publication No. H4-66076 A discloses a method of causing a shelled walnut to come into contact with gas beyond a critical state and removing a seed coat while a kernel is prevented from being damaged or decolored. However, a use of the gas beyond the critical state in this method causes an increase in work or an increase in cost, and thus there is also a concern about an adverse effect on the processed walnut.

Japanese Patent No. 4613005 B discloses a technology in which nuts such as a macadamia nut are cooled with liquid nitrogen so as to be fragmented and discloses that it is possible to peel an astringent seed coat by the technology. However, the present inventors provide description in the present specification and consider that it is difficult to sufficiently and efficiently perform separation of a fruit portion (seed portion) of the nut from a seed coat (astringent seed coat) covering the portion in a method described above. In addition, an object of the method described in Japanese Patent No. 4613005 B is to fragment the nuts, and thus the method is considered to be unsuitable for performing peeling without cracking of the nuts into very small pieces and obtaining peeled nuts that are large to the greatest extent.

Therefore, it is needless to say that there is a demand for a peeling method (hereinafter, referred to as “decoating” in some cases) in which an original flavor of the nuts is not damaged and an efficient peeling method of obtaining high-quality decoated nuts in which mixing of seed coats produced through decoating with the decoated nuts is suppressed as much as possible.

### RELATED DOCUMENT LIST

### Patent Documents

Patent Document 1: Japanese Patent Application Laid-Open Publication No. S62(1987)-239964

Patent Document 2: Japanese Patent Application Laid-Open Publication No. H4(1992)-66076

Patent Document 3: Japanese Patent No. 4613005 B

### SUMMARY OF THE INVENTION

An object of the present invention is to provide a method for manufacturing peeled nuts in which seed coats peel off without a damage to an original flavor of nuts while crushing the nuts into too small pieces is avoided, and high-quality decoated nuts are efficiently obtained with little mixing of seed coats generated through decoating with the decoated nuts.

Here, the present inventors have found that shelled raw material nuts are rapidly frozen in an atmosphere of −50° C. or lower and then are agitated, and thereby it is possible to perform peel nut portions off thin seed coats covering surfaces of the raw material nuts.

In addition, in a process of study, the present inventors notice that re-attachment easily occurs between nut portions from which thin seed coats peel off and the peeled-off thin seed coats. When the re-attachment occurs, re-attached thin seed coats are not easily separated even in a case where separation work of the nut portions from the thin seed coats is performed by a conventional method. Hence, the thin seed coats are mixed with the nuts obtained through the separation work, and it is needless to say that some thin seed coats remain. As a result, the decoated nuts to be obtained as described above and a product thereof cannot avoid having astringency due to the mixed thin seed coats. Therefore, it is desirable to prevent mixing with the thin seed coats as much as possible and to efficiently produce decoated nuts without the astringency due to the thin seed coats.

In such a circumstance, the present inventors have unexpectedly found that it is possible to prevent the re-attachment when the nut portions and the thin seed coats are present under a low-temperature condition. As a result of progressing a study based on such findings, when separation of the nut portions from the thin seed coat is performed under the low-temperature condition to the extent that it is possible to prevent the re-attachment, it is possible to efficiently perform the separation of the thin seed coats. As a result, mixing of the thin seed coats with the separated nut portions is successfully and significantly reduced. As will be described below, as a result of further progressing the study, in a case where the separation is performed by using a sieve in an atmosphere of −20° C. or lower, high-quality decoated nuts substantially with little mixing of the seed coats with the nut portions are successfully obtained in practice.

In this manner, such a series of steps is performed in the low-temperature condition like a state in which liquid nitrogen is present, and thus there is no concern that the original flavor of the nuts is damaged because heating is not performed. Therefore, it is possible to simply separate the thin seed coats with efficiency and high separation efficiency and obtain high-quality decoated nuts. In other words, the present inventors succeed in performing simple and efficient production of high-quality peeled nuts.

The present invention is made based on the findings.

In other words, according to the present invention, the following inventions are provided.

<1> A method for manufacturing peeled nuts includes: freezing shelled raw material nuts rapidly in a temperature condition of −50° C. or lower; peeling off thin seed coats from the nuts through an agitating or crushing process, in a state in which frozen nuts are frozen as are; and separating and removing the thin seed coats from the nuts in a low-temperature condition in which re-attachment of the thin seed coats to the thin seed coat-peeled nuts does not occur, and obtaining the peeled nuts.

<2> In the method according to <1>, the nuts are rapidly frozen in the temperature condition of −50° C. or lower by using liquid nitrogen or a freezing device.

<3> In the method according to <1> or <2>, the frozen nuts are agitated in a state in which ice grains or dry ice pellets are copresent with the nuts.

<4> In the method according to any one of <1> to <3>, a step of peeling off the thin seed coats from the frozen nuts is performed in a state in which liquid nitrogen or a brine refrigerated solution is present.

<5> In the method according to any one of <1> to <4>, in the low-temperature condition, a temperature is −15° C. or lower.

<6> In the method according to any one of <1> to <5>, the separation in the low-temperature condition means separation in a state in which the liquid nitrogen is present.

<7> In the method according to any one of <1> to <6>, the separation of the nuts from the thin seed coats is performed by performing sorting based on a difference in size and/or a difference in specific gravity between the nuts and the peeling-off thin seed coats.

<8> In the method according to any one of <1> to <7>, the nuts are walnuts.

<9> In the method according to any one of <1> to <8>, all steps from a step of freezing the raw material nuts to a step of separating the thin seed coats are executed in the low-temperature condition of −15° C. or lower.

### Advantageous Effects of Invention

According to the method for peeling the nuts of the present invention, it is possible to efficiently manufacturing high-quality decoated nuts without a damage to an original flavor of the nuts, and with little mixing of the seed coats generated through decoating with the decoated nuts. In addition, according to the method of the present invention, it is possible to peel off the seed coats while crushing into too small pieces is avoided, and thus it is possible to obtain the peeled nuts that are not fragmented and have a relatively large size.

In addition, some raw materials of imported nuts are thought to have been subjected to chemical treatment. However, such nut raw materials subjected to the chemical treatment are often very white (white like a soap) or often do not have either of a taste or a flavor, but rather the raw materials subjected to the chemical treatment becomes a target of a concern to consumers in some cases, in a state in which many people are health-conscious currently. In this respect, the method of the present invention is performed without chemical, and thus the method is considered to achieve a high added value so as to be accepted by health-conscious consumers without a concern about damage to the original taste or color of the nuts.

Further, the method according to the present invention employs a relatively simple configuration, and thus adjustment of a size or the like of an apparatus enables an amount of production to increase easily.

The decoated nuts (nuts without seed coats) obtained by the method of the present invention do not have strong astringency or bitterness and are very easy to eat, and thus the decoated nuts can be eaten as are or can become a paste, or it is possible to preferably use the decoated nuts as a beverage material or further squeezed mild nut oil (for example, walnut oil).

### BRIEF DESCRIPTION OF THE DRAWINGS

FIG. 1 shows an actual measurement result of a size of raw material nuts (walnuts) used in Example 1;

FIG. 2 shows an actual measurement result of a size of peeled walnuts obtained by Example 1; and

FIG. 3 shows a state of peeled walnuts obtained by Example 6 and ice (small white pieces) that is copresent when agitating is performed.

### MODE FOR CARRYING OUT THE INVENTION

Hereinafter, embodiments of the present invention will be described.

### Method for Peeling Nuts

As described above, a method for manufacturing peeled nuts according to the present invention includes: freezing shelled raw material nuts rapidly in a temperature condition of −50° C. or lower; peeling off thin seed coats from the nuts through an agitating or crushing process, in a state in which frozen nuts are frozen as are; and separating and removing the thin seed coats from the nuts in a low-temperature condition in which re-attachment of the thin seed coats to the thin seed coat-peeled nuts does not occur, and obtaining the peeled nuts. Incidentally, the method for manufacturing the peeled nuts can be rephrased as a method for peeling the nuts.

The raw material nuts used in the method of the present invention are obtained by removing shells of the nuts (being shelled) and naturally means the nuts covered with the thin seed coat (or astringent seed coat). In addition, the raw material nuts may be raw nuts; however, the raw material nuts may be roasted, boiled, or steamed nuts.

In addition, the raw material nuts may be used regardless of a size or variety, as long as the nuts have been shelled. Examples of nuts include an almond, a Brazil nut, a walnut, a macadamia nut, a pecan nut, a hazelnut, a pistachio, or the like. In the present invention, the nuts are preferably the walnuts, the pecan nuts, the Brazil nuts, and more preferably the walnuts.

In addition, the “peeling” means that the thin seed coats covering an uneven surface of the shelled raw material nuts peel off from nut portions without the thin seed coats or are separated to be removed from the nut portions, and the nuts in decoated state (or nuts without the seed coats) are obtained.

### Optional Preprocessing

The size of the shelled raw material nuts used in the method of the present invention is not particularly limited. As described above, according to the present invention, it is possible to peel off the seed coats from the nuts while crushing into too small pieces is avoided, and thus there is no need to perform fragmentation. Prior to the freezing with the liquid nitrogen, an impact may be applied to the raw material nuts in advance, or the raw material nuts may be crushed in advance to be divided into small pieces, as necessary. Such preliminary processing enables peeling-off of the thin seed coat from the nuts to be easily performed, and thus it is possible to expect an increase in work efficiency or a reduction in work time.

However, in the present invention, as will be described below, the nuts are rapidly frozen such that it is easy to perform the peeling-off of the thin seed coats by performing the agitating or crushing process in the frozen state as is; however, it is not essential to perform the fragmentation of the nuts for easy peeling. The nuts are crushed into small pieces such that it is easy to perform the peeling-off of the thin seed coats in some cases. However, in the present invention, as one of characteristics, regardless of such fragmenting process, the thin seed coats can easily peel off through the rapid freezing of the nuts and the agitating or crushing process in the frozen state as is.

It is desirable that the fragmentation of the nuts does not proceed much, because a product value is high in this case. Therefore, as in the present invention, the rapid freezing and the agitating or crushing process in the frozen state as is are combined, and thereby it is possible to peel off the thin seed coat from the nuts without unnecessary progression of the fragmentation.

In a case where the shelled raw material nuts used in the method of the present invention are stored at normal temperature such as room temperature, the nuts may remain in the low-temperature condition (for example, at −15° C. or lower) in advance and may be cooled prior to the freezing with the liquid nitrogen or the like. For example, in order to achieve the low-temperature condition, the raw material nuts may be stored in a freezer in advance or may be cooled in advance by using dry ice, dry ice pellets, or the like. Alternatively, as will be described below, the raw material nuts may be cooled in advance by directly using the liquid nitrogen used for separating the nuts from the thin seed coats.

### Freezing Treatment

In the present invention, first, the shelled raw material nuts (that is, the nuts to be decoated) are rapidly frozen in the temperature condition of −50° C. or lower.

In a rapid freezing treatment, the rapid freezing may be performed by using the liquid nitrogen (boiling point: −196° C.) (hereinafter, referred to as “LN2” in some cases). Alternatively, in order to perform the rapid freezing treatment, the raw material nuts may be frozen at −50° C. or lower (for example, about −50° C.) by using another freezing solution such as a brine refrigerated solution with which it is possible to perform the freezing treatment or using another freezing device, instead of or together with the liquid nitrogen.

In other words, the shelled nuts are immersed in the liquid nitrogen or the brine refrigerated solution, the liquid nitrogen or the brine refrigerated solution is poured to the nuts, or the other freezing device is used such that the shelled nuts are rapidly cooled and frozen in the temperature condition of −50° C. or lower. The rapid or drastic freezing treatment is considered as one of important treatments for the easy peeling-off of the thin seed coats from the nuts.

In a case where the nuts are frozen with the liquid nitrogen, for example, a container is prepared, the nuts are put into the container, and the liquid nitrogen is poured therein.

Here, the container to be used is not particularly limited as long as low-temperature brittleness does not occur due to the liquid nitrogen. Hence, as a material of the container, it is possible to use austenite stainless steel such as SUS304 or SUS316, and a material such as copper, by which the low-temperature brittleness does not occur, may also be used. In addition, a conical type or a cylindrical type may be used as a shape of the container to be used, and the container may have a jacket structure for insulation or, preferably, a vacuum insulation structure. It is desirable to use the container having the vacuum insulation structure because it is possible to suppress evaporation when the liquid nitrogen is used.

Therefore, a commercial mixer or the like may be used as the container, for example.

In a case where the nuts are frozen by using the container, in general, the nuts are put into the container by an amount of 50% to 80% of a container capacity, and the liquid nitrogen is poured therein. For example, an amount of the liquid nitrogen to be used may be 1 L to 3 L per 1 kg of the raw material nuts. Specifically, it is desirable that the liquid nitrogen is poured such that the raw material nuts are visually immersed in the liquid nitrogen. In addition, when the liquid nitrogen is poured to the raw material nuts, in general, the liquid nitrogen is first evaporated until the raw material is frozen, and thus the liquid nitrogen may be added, as necessary, such that the raw material nuts are appropriately immersed, while a state thereof is checked. Even when the liquid nitrogen is too much added, the freezing temperature does not change, and expensive liquid nitrogen is wastefully evaporated. Therefore, it is desirable to appropriately add the liquid nitrogen.

Even in a case of using the brine refrigerated solution, it is possible to perform the treatment in the same procedure and by using the device such as the same container as those with the liquid nitrogen. However, the brine refrigerated solution has a boiling point different from that of the liquid nitrogen, and thus it is desirable to immerse the nuts in the brine refrigerated solution refrigerated in a refrigerator.

In the present invention, in a case of using the brine refrigerated solution, the brine refrigerated solution has a temperature of −25° C. or lower desirably, and preferably about −30° C. It is preferable to use ethanol as the brine refrigerated solution, because ethanol is safe and has no influence on a taste in order to perform the treatment on edible nuts. A preferable example of the brine refrigerated solution includes an ethanol solution at −30° C.

In a case where the freezing device is used to set the temperature condition of −50° C. or lower, a freezing device that is capable of realizing a condition of −50° C. or lower is prepared, and thereby it is possible to bring the same container in the realized atmosphere of −50° C. (or lower) and to perform the treatment. However, in this case, it is desirable that the treatment is performed in a state of maintaining an atmosphere temperature of −50° C. in a sealed room or a small amount of LN2 is poured and the temperature of the raw material is prevented from increasing.

### Agitating or Crushing Step

Then, in the present invention, in a state in which the nuts frozen by the liquid nitrogen, the brine refrigerated solution, or the other freezing device are frozen as are, the nuts are peeled off the thin seed coats through the agitating or crushing process. Incidentally, in this case, it is desirable that the liquid nitrogen or the like used for the freezing is evaporated from the nuts frozen so as to be peeled such that the surfaces of the nuts are dried in general; however, the brine refrigerated solution remain on the surfaces of the nuts depending on the brine refrigerated solution to be used, in some cases. In the cases, a process of causing the remaining brine refrigerated solution to be evaporated may be performed as necessary.

The frozen nuts are subjected to the agitating or crushing process, in the frozen state as is, and thereby the raw material nuts rub are rubbed against each other in the frozen state. Consequently, the thin seed coat is likely to peel off. In this case, there is no need to crack the nuts into fragments in order to peel off the thin seed coats and, in the present invention, it is also possible to easily peel off the thin seed coats without performing the fragmentation. In addition, when the raw material nuts are rubbed against each other in the frozen state, the nuts are cracked such that it is also easy to peel off the thin seed coat in this case. When the raw material nuts in a state in which the thin seed coats easily peel off are further subjected to the agitating or crushing process, it is possible to completely or partially peel off the thin seed coats from the raw material nuts.

In general, the agitating is performed by using an agitating device. A state of an agitating blade in the agitating device is not particularly limited as long as the raw material nuts are rubbed against each other by the agitating such that it is possible to cause the thin seed coat to peel off. For example, a device having a mixer shape, a paddle type device, a spiral type device, a propeller type device, an anchor type device, an H-type device, or the like may be used as the agitating device, and it is possible to appropriately change the device depending on a variety or an amount of preparation of the nuts. In addition, it is possible to use a rotating/revolving agitator as the agitating device depending on the shape of the agitating blade.

Incidentally, in a case of using the agitating device, the agitating device may be attached, in advance, to the container to be used when the raw material nuts are frozen with the liquid nitrogen, or the agitating device may be prepared separately and used during an agitating step. In this case, it is desirable that the agitating device is cooled in advance such that the frozen state of the frozen nuts is maintained. Preferably, the agitating is executed in an atmosphere of the liquid nitrogen or in presence of the brine refrigerated solution.

A rotating speed of the agitating changes depending on the size of the container or a shape and size of the agitating blade; however, it is necessary to secure the rotating speed to the extent that the raw material nuts are rubbed against each other such that the thin seed coats can peel off, and the rotating speed may be at least about 480 rpm, for example. A time for the agitating process changes depending on the state of the nuts to be agitated, the shape and size of the agitating blade, a throughput; however, the time is about two to ten minutes, for example.

In a case using the agitating, it is possible to adjust a seed coat peeling state by the agitating time and the rotating speed of the agitating.

According to a preferred example of the present invention, in a case where the frozen raw material nuts are agitated so as to peel off the seed coats, ice grains or dry ice pellets may be copresent with the raw material nuts, and the agitating may be performed. The ice grains or the dry ice pellets are copresent with the nuts, thereby, playing roles of an abrasive, such that it is possible to promote peeling off and removing of the thin seed coats from the raw material nuts. Consequently, it is possible to expect a reduction in agitating time and improvement in peeling efficiency by the agitating, and it is possible to expect generation of more peeled nuts in a good state.

Here, in a case where the agitating is performed in a state in which the liquid nitrogen is present, for example, it is possible to gradually add water therein, and thereby it is possible to cause the ice grains to be formed. The ice grains are, preferably, ice crystals.

Hence, according to a preferred example of the present invention, the frozen nuts may be agitated in a state in which the ice crystals or the dry ice pellets are copresent with the nuts, and more preferably the frozen nuts may be agitated in a state in which the ice crystals are copresent with the nuts.

Incidentally, a temperature of ice chunks used returns to normal temperature on a mesh of the sieve, for example, and thereby the ice chunks thaw naturally and can be dropped down from the sieve, and then it is possible to save time and effort to dry the nuts.

The nuts may be subjected to the crushing process, in a state in which frozen nuts are frozen as are.

The crushing process may be rephrased as a grinding process, and it is possible to use a conventional grinding machine in the process. Examples of the grinding machine include a pin mill, a hammer mill, or the like. In a case of using the pin mill, the hammer mill, or the like, it is desirable that the apparatus is coupled with the freezing device by the liquid nitrogen. In this manner, it is possible to maintain the state in which the nuts to be processed are frozen and to expect that the seed coats are likely to peel off by the impacts when grinding is performed.

Preferably, the crushing process is executed in the atmosphere of the liquid nitrogen or in presence of the brine refrigerated solution.

Incidentally, there is a possibility that the raw material nuts are likely to be crushed into too small pieces by a grinding machine to be used in the crushing process, and thus, in this case, adjustment of a use condition or the like of the grinding machine may be taken into account such that the nuts are not crushed into too small pieces.

### Separating Process

Then, in the present invention, the thin seed coats are separated and removed from the nuts and the peeled nuts are obtained in the low-temperature condition in which the re-attachment of the thin seed coats to the thin seed coat-peeled nuts does not occur. In other words, the nuts and the thin seed coats are separated from each other through the agitating or crushing process of the frozen nuts while the re-attachment of peeled-off thin seed coats to the thin seed coat-peeled nuts is prevented from occurring such that it is not difficult to perform separation.

When the thin seed coat-peeled nuts and the thin seed coats are separated from each other, for example, separation may be performed by using a difference in size or a difference in specific gravity between fruit portions of the nuts and the thin seed coats. However, the present inventors verifies that, when a state of the nuts changes from the frozen state to a state at normal temperature, the fruit portions of the nuts and the thin seed coats tend to be re-attached to each other. This is considered to be due to an oil content in the nuts, and a state in which the frozen state changes to a normal temperature state, and thereby the oil content comes out is predicted to be one of causes of the re-attachment. Therefore, it is desirable that, when the separation is performed, the thin seed coat-peeled nuts and the thin seed coats stay and the separation is performed in the low-temperature condition (here, collectively referred to as a “re-attachment preventive low-temperature condition) in which the re-attachment of the thin seed coats to the nuts does not occur or the re-attachment is difficult to occur.

An example of the low-temperature condition includes a temperature lower than the normal temperature. The temperature is, preferably, −15° C. or lower and, more preferably, −20° C. or lower.

The present inventors conducted the following study in the low-temperature condition. In other words, according to a known document, the oil content contained in walnuts is mainly 57.4% of linoleic acid, 19.1% of oleic acid, 13.1% of α-linolenic acid, and 10.4% of others. Thus, when a melting point of the oil contents is studied, the melting point of the linoleic acid is −5° C., that of the oleic acid is 13.4° C., and that of α-linolenic acid is −11° C. Here, acid having the lowest melting point is −11° C. of α-linolenic acid. As a result of a study based the oil contents, the present inventors find that a state in which the nuts such as the walnuts contain fat and are frozen is maintained as long as a temperature is lower than that of the oil contents, preferably −15° C., and more preferably −20° C. or lower.

Accordingly, as the low-temperature condition in which the re-attachment of the thin seed coats to the nuts does not occur or the re-attachment is difficult to occur, the temperature is set to preferably −15° C. or lower and more preferably −20° C. or lower.

Further, in the present invention, it is considered to be more preferable that the separation is performed in the presence of the liquid nitrogen or in the atmosphere of −20° C. or lower as a condition of the separation of the thin seed coats from the nuts in the low-temperature condition in which the re-attachment of the thin seed coats to the thin seed coat-peeled nuts, which is in a further lower temperature than the above-described condition.

As described above, in a case of obtaining the peeled nuts according to the present invention, it is preferable that a series of steps is performed under the low-temperature condition from the viewpoint of preventing the re-attachment of the thin seed coats. Accordingly, according to the preferred example of the present invention, all steps from a step of freezing the raw material nuts to a step of separating the thin seed coats are executed in the low-temperature condition of at least −15° C. or lower. In addition, according to the preferred example of the present invention, all of the steps from the step of freezing the raw material nuts to the step of separating the thin seed coats are executed in the atmosphere of the liquid nitrogen or −20° C. or lower.

As described above, according to the preferred example of the present invention, the separation of the thin seed coats from the nuts is performed by performing sorting based on a difference in size and/or a difference in specific gravity between the nuts and the peeling-off thin seed coats.

Such a separation method includes a separation method in which the sieve or the mesh is used.

For example, a container having a mesh bottom is used, the nuts and the thin seed coats are transferred to the container and are vibrated in right, left, top and bottom directions, or the agitating is performed by the agitator. Alternatively, the container that is integrally formed with an original agitating container may be used. However, in this case, it is desirable to impart a function of a drain plug or the like, through which a liquid can be discharged, on a lower portion.

Alternatively, in the low-temperature condition, the sieve is used, the nuts and the thin seed coats are placed thereon, the sieve finely moves in front, rear, right, and left directions, and the seed coats attached to the nuts can drop downward from the sieve. A vibration sieve machine may be used as the sieve.

In still another example, while the low-temperature condition is taken into consideration, a conventional separating device such as a cyclonic separator may be used.

In a case where the separation is performed by the sieve, a vibrating or agitating time for the process changes depending on the size of the nuts as the raw material; however, it is possible to perform the vibration or agitation for one to ten minutes, for example.

In a case of using the sieve, it is desirable to appropriately select a sieve having a size of the mesh to the extent that fruits do not fall downward from the sieve.

It is desirable to perform the separation in presence of the liquid nitrogen; however, as long as it is possible to maintain the low-temperature condition, the separation may be performed in a room in the atmosphere of −20° C. or by using the brine refrigerated solution, water (cold water), or a medium that is unlikely to influence the quality of the nuts, other than media described above. Incidentally, in a case of using water, water suitable for drinking is used.

When the separation is further performed, sieving or the like may performed, then, the nuts may be washed with another media such as the liquid nitrogen, the brine refrigerated solution, or water (cold water) such that a residue of the thin seed coats is to be removed.

In a case where the final washing is performed with water, centrifugal separation or the like is rapidly performed so as to prevent bacterial contamination, marginal moisture is removed, and then the process may proceed to a dry step. In this case, in order to prevent oxidation of the nuts, it is necessary to perform the dry step rapidly at a temperature as low as possible, and thus it is desirable to perform the step by a vacuum dryer.

In a case where washing with the liquid nitrogen is completed, and the nuts thaw in the state as is, the fruit absorbs moisture in air, frost is likely to be attached, and there is a high possibility that the nuts will absorb moisture. Therefore, the fruit may be moved to a separated container in a frozen state as is, and the fruit may thaw without condensation.

After the separation, the fruit portions of the nuts are collected, whereas the liquid nitrogen as a waste liquid may be reused in the next freezing as is. After the nuts are temporarily transferred to a container, a bag, or the like, a port is lightly blocked, the nuts thaw while only expanded N2 (nitrogen) is released, and thereby it is possible to prevent the frost from being formed in the inside.

A step of further separating a mixture from the obtained nuts by using a conventional separator (for example, cyclonic wind separating device) or the like as necessary.

The finally obtained nuts may be packaged, become powder, become a grind paste, or become a beverage material, or the nuts may be compressed and nut oil (for example, walnut oil) or the like may be obtained.

### EXAMPLES

Hereinafter, the present invention will be described in detail based on the following examples, but the invention is not limited thereto.

### Example 1

As the raw material nuts for a test, 900 g of walnuts (LSP) (shelled walnuts for business use) were prepared.

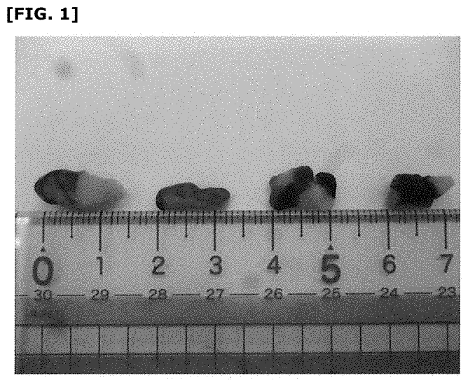

Incidentally, as a result of actually measuring a size of the walnuts (LSP) as the raw material, the size was in a range of 7 to 14 mm (FIG. 1).

The walnuts were put into a container of a mixer equipped apparatus (KENMIX model KMM770 manufactured by AICOHSHA MFG CO., LTD.), and about 2 L of liquid nitrogen was poured therein (evaporation was fast, and thus the liquid nitrogen was added in addition to 2 L). Incidentally, a mixer or a sieve was used after cooling was performed at −20° C. for 45 minutes.

After the walnuts were entirely put in the liquid nitrogen and a waiting time for the boil to settle passed, an anchor type agitating blade was attached, and the agitating was performed for five minutes at a rotating speed of about 480 rpm in a state in which the liquid nitrogen was present as was.

After the agitating was ended, the walnuts were transferred to a sieve having 10 mesh (sieve opening: 1.7 mm), the liquid nitrogen was poured into a bowl having a size of about 5 L, and the sieve was finely vibrated in the liquid nitrogen such that the seed coats attached to the fruits of the walnuts dropped through the sieve for three minutes.

As a result, 69 g of a residue of the seed coat was removed, and the peeled nuts (walnuts) were obtained as a target. A manufacturing yield was 92.3%.

As a result of a visual observation of the obtained peeled walnuts, most of the thin seed coats were checked to have been removed.

Incidentally, as a result of actually measuring the size of the obtained peeled walnuts, the size was in a range of 2 to 8 mm.

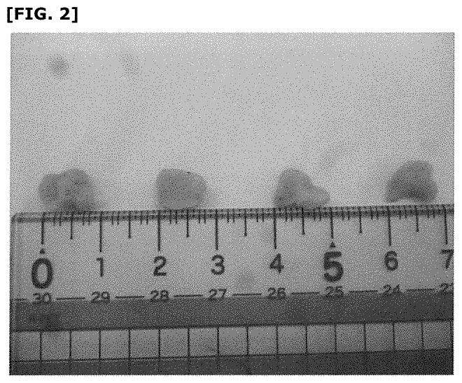

As described above, there are fragmentations smaller than raw material walnuts; however, a large amount of the walnuts having a size of 8 mm or having a size approximate to 8 mm, that is, non-fragmented walnuts or little fragmented walnuts, were contained (FIG. 2). Consequently, according to the method of the present invention, it was possible to check that it was possible to peel off the thin seed coats from the nuts by maintaining the size of the nuts or without the fragmentation.

### Example 2

Here, the same test as that of Example 1 was conducted by using the same raw material and device as those of Example 1 except that sieving was performed for five minutes as a test condition.

As a result, 67 g of the residue of the seed coat was removed, and the peeled nuts (walnuts) were obtained as a target. A manufacturing yield was 92.5%.

As a result of the visual observation of the obtained peeled walnuts, most of the thin seed coats were checked to have been removed.

### Example 3

Here, the same test as that of Example 1 was conducted by using the same raw material and device as those of Example 1 except that the agitating was performed for five minutes as a test condition, instead of the sieving.

As a result, 67 g of the residue of the seed coat was removed, and the peeled nuts (walnuts) were obtained as a target. A manufacturing yield was 92.5%.

As a result of the visual observation of the obtained peeled walnuts, most of the thin seed coats were checked to have been removed.

### Example 4

Here, the same test as that of Example 1 was conducted by using the same raw material and device as those of Example 1 except that 5 kg of the raw material nuts were used, the agitating was performed on the basis of 1 kg of the raw material, and the sieving was performed for three minutes, as test conditions. Incidentally, twice the liquid nitrogen of Example 1 was used.

As a result, 300 g of the residue of the seed coat was removed with respect to 5 kg of the raw material nuts, and the peeled nuts (walnuts) were obtained as a target. A manufacturing yield was 94%.

As a result of the visual observation of the obtained peeled walnuts, most of the thin seed coats were checked to have been removed.

### Comparative Example 1

Here, the same test as that of Example 1 was conducted by using the same raw material and device as those of Example 1 except that 5 kg of the raw material nuts were used, the agitating was performed, and the sieving was performed for three minutes on the basis of 500 g of the raw material, as test conditions.

However, since a time was taken for such a procedure, a temperature of the walnuts to be processed increased (temperature higher than −15° C.) during the manufacturing including the separating step of the thin seed coats. Therefore, bleeding of oil from the walnuts was checked.

As a result, re-attachment of the peeled-off thin seed coats to the thin seed coat-peeled walnuts occurred in the sieving. In addition, the mesh was clogged, and it was not possible to clearly perform the separation.

Incidentally, clogging of the mesh was considered by the oil bleeding from the walnuts.

### Example 5: Freezing of Raw Material Nuts with Brine Refrigerated Solution

First, as the raw material nuts for a test, 300 g of walnuts (LSP) were prepared. The nuts were put into the container of the mixer equipped apparatus (KEN MIX model KMM770 manufactured by AICOHSHA MFG CO., LTD.), and 100 g of one third of the brine refrigerated solution (alcohol degree: 99%) in terms of the weight of the raw material and 200 g of two thirds of the liquid nitrogen in terms of the weight of the raw material were poured into a bowl in this order, and the raw material was frozen at a temperature of −50° C. or lower.

As a result, fragmented materials having a small size of the raw material were obtained less than in a case of using the liquid nitrogen, and an effect of keeping the size was recognized.

### Example 6: Case of Copresence and Agitation of Ice Crystals

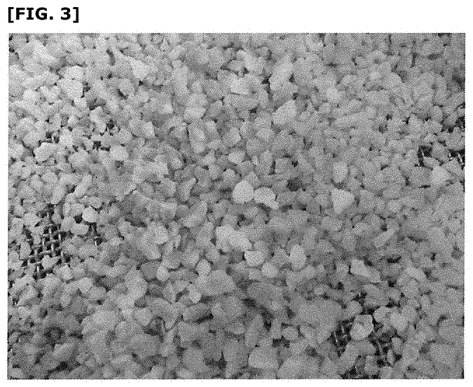

As the raw material nuts for a test, 300 g of walnuts (LSP) were prepared. The nuts were put into the container of the mixer equipped apparatus (KENMIX model KMM770 manufactured by AICOHSHA MFG CO., LTD.), and the liquid nitrogen was poured therein to the extent that the raw material was not seen. The anchor type agitating blade was attached, and the agitating was performed at the rotating speed of about 480 rpm in a state in which the liquid nitrogen was present as was. In this case, water was poured little by little into a container having a capacity of 30 g immediately after the agitating was started, and ice crystals were formed. The agitating was performed in the presence of the ice crystals (FIG. 3).

Example 6 is the same as Example 1 except for the description provided above, the sieving was performed, and the seed coats are separated from the peeled nuts (FIG. 3).

As a result, the ice crystals were considered to play a role of an abrasive, five minutes of the agitating time was taken in a case where the ice crystals were not used. As a result, the agitating time was performed for two minutes, and thereby it was possible to end a peeling process.

In addition, the agitating was performed by using dry ice pellets, instead of the ice crystals from water. As a result, the dry ice pellets played a role of the abrasive so as to improve the peeling-off of the thin seed coats; however, an effect obtained by the role as the abrasive was higher in a case of using the ice crystals.

Then, a temperature of ice chunks returned to normal temperature on the mesh of the sieve, and thus the ice chunks dropped down from the sieve. As a result, time and effort to dry the walnuts were saved.

What is claimed is:

1. A method for manufacturing peeled nuts, comprising:
freezing shelled raw material nuts rapidly in a temperature condition of −50° C. or lower;
peeling off thin seed coats from the nuts through an agitating or crushing process, in a state in which frozen nuts are frozen as are; and
separating and removing the thin seed coats from the nuts in a low-temperature condition in which re-attachment of the thin seed coats to thin seed coat-peeled nuts does not occur, and obtaining the peeled nuts.

2. The method for manufacturing peeled nuts according to claim 1, wherein
the nuts are rapidly frozen in the temperature condition of −50° C. or lower by using liquid nitrogen or a freezing device.

3. The method for manufacturing peeled nuts according to claim 1, wherein
the frozen nuts are agitated in a state in which ice grains or dry ice pellets are copresent with the nuts.

4. The method for manufacturing peeled nuts according to claim 1, wherein
a step of peeling off the thin seed coats from the frozen nuts is performed in a state in which liquid nitrogen is present.

5. The method for manufacturing peeled nuts according to claim 1, wherein
in the low-temperature condition, a temperature is −15° C. or lower.

6. The method for manufacturing peeled nuts according to claim 1, wherein
the separation in the low-temperature condition is performed in a state in which the liquid nitrogen is present.

7. The method for manufacturing peeled nuts according to claim 1, wherein
the separation of the nuts from the thin seed coats is performed by performing sorting based on a difference in size and/or a difference in specific gravity between the nuts and the peeling-off thin seed coats.

8. The method for manufacturing peeled nuts according to claim 1, wherein
the nuts are walnuts.

9. The method for manufacturing peeled nuts according to claim 1, wherein
all steps from a step of freezing the raw material nuts to a step of separating the thin seed coats are executed in the low-temperature condition of −15° C. or lower.
